(19) United States
(12) Patent Application Publication
(10) Pub. No.: US 2026/0352761 A1
(43) Pub. Date: Nov. 5, 2026

(54) CALL SCREENING WITH SMART REPLIES

(71) Applicant: Google LLC, Mountain View, CA (US)

(72) Inventors: Lyubov Farafonova, San Francisco, CA (US); Liran Hana Peretz, Tel Mond (IL); Yoav Tzur, Tel Aviv (IL); Ran El Manor, Tel Aviv (IL); Omer Amos Barak, Tel Aviv (IL); Avital Friedland, Tel Aviv (IL); Oded Meri, Tel Aviv (IL)

(21) Appl. No.: 19/483,814

(22) PCT Filed: May 10, 2024
(86) PCT No.: PCT/US2024/028876

§ 371 Date: Nov. 12, 2025

Related U.S. Application Data
(60) Provisional application No. 63/502,298, filed on May 15, 2023.

(51) Int. Cl. H04M 3/436; H04M 3/22; H04M 3/527

(52) U.S. Cl. CPC H04M 3/4365; H04M 3/2218; H04M 3/527

(57) ABSTRACT

A computing device may establish a call with a remote computing device and may conduct a conversation in the call with the remote computing device. The computing device may determine, based at least in part, on contextual information associated with the call, one or more candidate replies. The computing device may receive an indication of a user input that selects a candidate reply from the one or more candidate replies and. may, in response to receiving the indication of the user input that selects a candidate reply, send a. reply in the conversation that corresponds to the candidate reply.

### CLAIM OF PRIORITY

This application is a PCT with provisional priority of U.S. Provisional Patent Application No. 63/502,298, filed 15 May 2023, the entire contents of which is incorporated herein by reference.

### BACKGROUND

The widespread usage of mobile devices, such as smartphones, enables users to be able to place and receive calls at any place and at any time. As such, a user of a mobile device may often receive calls at inconvenient times, such as when the user is busy. Further, a user of a mobile device may also receive spam calls, such as robocalls, and such spam callers may fake or spoof their number in order to bypass anti-spam tools. A user of a mobile device may therefore be reluctant to answer incoming calls and may instead allow incoming calls to go to voicemail.

### SUMMARY

In general, the techniques of this disclosure are directed to techniques for enabling a computing device to screen incoming calls received by the computing device. The computing device may screen an incoming call to gather information related to the call, such as to determine the identity of the calling party and to determine the purpose of the call. Such information gathered by the computing device may enable the user of the computing device to determine whether to pick up the call, whether the call is a spam call, and the like.

In accordance with aspects of this disclosure, the computing device may screen an incoming call without participation by the user of the computing device. Rather, the computing device may be able to answer the call by conducting a natural language conversation with the calling party without user input to determine information related to the call. As the computing device conducts screening of an incoming call, the computing device may output a real-time transcript of the conversation with the calling party so that the user of the computing device may be able to follow along with the conversation.

As the computing device screens the call, the computing device may determine, based on the context of the call, one or more candidate replies for replying to what is being said by the calling party in the call. The computing device may determine one or more candidate replies that are relevant to the conversation, such as to answer a question or query received in the conversation. The user of the computing device may select a candidate reply out of the one or more candidate replies, and the computing device may generate and send a reply in the conversation that corresponds to the selected candidate reply.

In one example, this disclosure describes a method that includes establishing, by one or more processors of a computing device, a call with a remote computing device, and conducting, by the one or more processors, a conversation in the call with the remote computing device. The method may further include determining, by the one or more processors and based at least in part on contextual information associated with the call, one or more candidate replies, receiving, by the one or more processor, an indication of a user input that selects a candidate reply from the one or more candidate replies, and, in response to receiving the indication of the user input that selects the candidate reply, sending, by the one or more processors, a reply in the conversation that corresponds to the candidate reply.

In another example, this disclosure describes a computing device that includes a memory and one or more processors implemented in circuitry in communication with the memory. The one or more processors may be configured to establish a call with a remote computing device, conduct a conversation in the call with the remote computing device, determine, based at least in part on contextual information associated with the call, one or more candidate replies, receive an indication of a user input that selects a candidate reply from the one or more candidate replies, and, in response to receiving the indication of the user input that selects the candidate reply, send a reply in the conversation that corresponds to the candidate reply.

In another example, this disclosure describes a non-transitory computer-readable storage medium encoded with instructions that, when executed by one or more processors, cause the one or more processors to establish a call with a remote computing device, and conduct, by the one or more processors, a conversation in the call with the remote computing device. The instructions may further cause the one or more processors to determine, based at least in part on contextual information associated with the call, one or more candidate replies, receive an indication of a user input that selects a candidate reply from the one or more candidate replies, and, in response to receiving the indication of the user input that selects the candidate reply, send a reply in the conversation that corresponds to the candidate reply.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIGS. 1A and 1B are conceptual diagrams illustrating an example environment for performing call screening with smart replies, in accordance with one or more aspects of the present disclosure.

FIG. 2 is a block diagram illustrating further details of an example computing device, in accordance with one or more aspects of the present disclosure.

FIGS. 3A and 3B illustrate techniques for call screening of incoming calls, in accordance with aspects of this disclosure.

FIG. 4 illustrates additional techniques for call screening, in accordance with aspects of this disclosure.

FIG. 5 is a flowchart illustrating an example technique for determining one or more candidate replies, in accordance with aspects of this disclosure.

FIG. 6 illustrates example candidate replies associated with use cases of a call, in accordance with aspects of this disclosure.

FIG. 7 is a flowchart illustrating example operations performed by an example computing device that is configured to perform call screening, in accordance with one or more aspects of the present disclosure.

### DETAILED DESCRIPTION

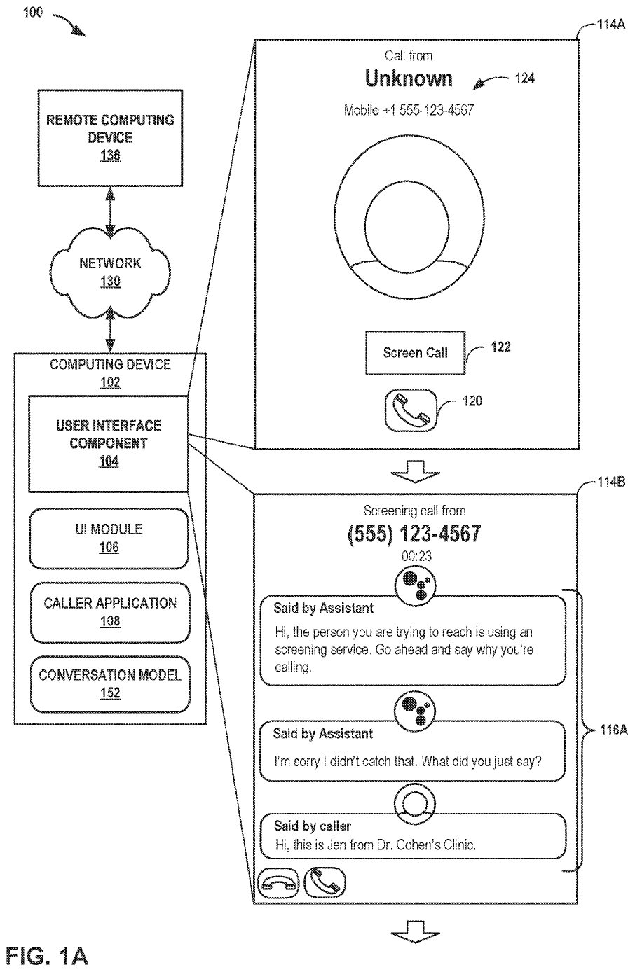

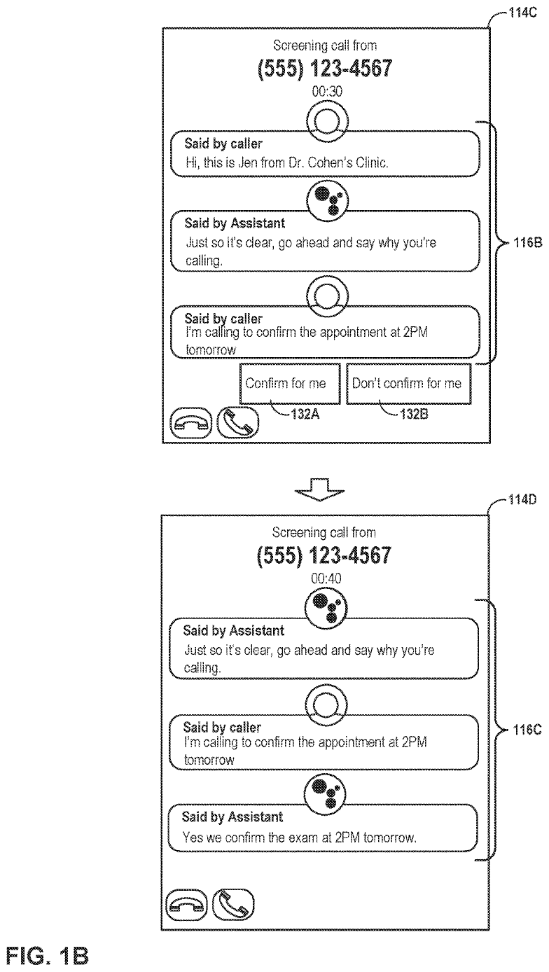

FIGS. 1A and 1B are conceptual diagrams illustrating an example environment for performing call screening with smart replies, in accordance with one or more aspects of the present disclosure. In the example of FIGS. 1A and 1B, environment 100 may include computing device 102 that connects to network 130 to place and receive calls to and more remote communication devices, such as remote computing device 136.

As shown in FIG. 1A, computing device 102 may represent an individual mobile or non-mobile computing device. Examples of computing device 102 include a mobile phone, a tablet computer, a laptop computer, a desktop computer, a server, a mainframe, a set-top box, a television, a wearable device (e.g., a computerized watch, computerized eyewear, computerized headphones, computerized gloves, etc.), a home automation device or system (e.g., an intelligent thermostat or home assistant device), a personal digital assistant (PDA), a gaming system, a media player, an e-book reader, a mobile television platform, an automobile navigation or infotainment system, or any other type of mobile, non-mobile, wearable, and non-wearable computing device.

Computing device 102 may connect to network 130 to place and receive calls to and from remote computing devices, such as remote computing device 136. Network 130 represents public or private communications network, such as Wi-Fi, one or more wireless wide area networks (e.g., a wireless cellular network, a satellite network, and/or a Free-Space Optical Communication network), one or more telephony network, such as one or more Public Switched Telephone Networks (PTSNs), one or more VoIP services, and/or other types of networks, for transmitting data between computing systems, servers, and computing devices, such as over the Internet. Network 130 may include one or more network hubs, network switches, network routers, or any other network equipment, that are operatively inter-coupled thereby providing for the exchange of information between computing device 102 and remote computing devices, such as remote computing device 136. Computing device 102 and remote computing devices, such as remote computing device 136 may transmit and receive data across network 130 using any suitable communication techniques. Computing device 102 may be operatively coupled to network 130 using respective network links, such as Ethernet, Wi-Fi, a cellular connection, or any other types of wired and/or wireless network connections.

Network 130 may implement any suitable technology and may include any suitable networks that enable computing device 102 to place and receive calls to and from remote computing devices. In some examples, network 130 may implement an IP Multimedia Subsystem (IMS) that manages call sessions, including call routing, authentication and billing. The IMS may also act as a Session Initiation Protocol (SIP) server that uses SIP to perform call setup and teardown functions and to perform signaling and messaging protocols used for calls between computing devices. In some examples, network 130 may implement the functionality of an Evolved Packet (EPG) core or a System Architecture Evolution (SAE) core to handle communication between devices connected to network 130 and to networks external to network 130.

Remote computing device 136 represents a device that is connected to network 130 to make and receive calls, such as voice calls and/or video calls. Examples of remote computing device 136 include a landline telephone, a mobile phone, a tablet computer, a laptop computer, a desktop computer, a satellite phone, or any other type of device that can communicate with network 130.

Computing device 102 includes user interface component (UIC) 104, user interface module 106 (“UI module 106”), caller application 108, and conversation model 152. UIC 104 of computing device 102 may function as an input device for computing device 102 and as an output device for computing device 102. UIC 104 may be implemented using various technologies. For instance, UIC 104 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology, such as radar-based presence-sensitive technology millimeter wave-based presence-sensitive technology, ultra-wideband-based presence-sensitive technology, and the like. In some examples, UIC 104 may function as an input device using one or more audio input devices, such as one or more microphones. UIC 104 may function as an output (e.g., display) device using any one or more display devices, such as a liquid crystal display (LCD), dot matrix display, light emitting diode (LED) display, microLED, organic light-emitting diode (OLED) display, e-ink, or similar monochrome or color display capable of outputting visible information to a user of computing device 102. In some examples, UIC 104 may function as an audio output device and may include one or more speakers, one or more headsets, or any other audio output device capable of outputting audible information to a user of computing device 102.

In some examples, UIC 104 of computing device 102 may include a presence-sensitive display that may receive tactile input from a user of computing device 102. UIC 104 may receive indications of the tactile input by detecting one or more gestures from a user of computing device 102 (e.g., the user touching or pointing to one or more locations of UIC 104 with a finger or a stylus pen). UIC 104 may present output to a user, for instance at a presence-sensitive display. UIC 104 may present the output as a graphical user interface (e.g., graphical user interfaces 114A-114D), which may be associated with functionality provided by computing device 102. For example, UIC 104 may present various user interfaces of components of a computing platform, operating system, applications (e.g., caller application 108), or services executing at or accessible by computing device 102 (e.g., an electronic message application, an Internet browser application, a mobile operating system, etc.). A user may interact with a respective user interface to cause computing device 102 to perform operations relating to a function.

UI module 106, caller application 108, and conversation model 152 may perform operations described herein using software, hardware, firmware, or a mixture of both hardware, software, and firmware residing in and executing on computing device 102 or at one or more other remote computing devices. In some examples, UI module 106, caller application 108, and conversation model 152 may be implemented as hardware, software, and/or a combination of hardware and software. Computing device 102 may execute UI module 106, caller application 108, and conversation model 152 with one or more processors. Computing device 102 may execute any of UI module 106, caller application 108, and conversation model 152 as or within a virtual machine executing on underlying hardware. UI module 106 and caller application 108 may be implemented in various ways. For example, any of UI module 106, caller application 108, and conversation model 152 may be implemented as a downloadable or pre-installed application or “app.” In another example, any of UI module 106, caller application 108, and conversation model 152 may be implemented as part of an operating system of computing device 102. Other examples of computing device 102 that implement techniques of this disclosure may include additional components not shown in FIG. 1A.

In the example of FIG. 1A, conversation model 152 may include a hardware device having various hardware, firmware, and software components. However, FIG. 1A illustrates only one particular example of conversation model 152, and many other examples of conversation model 152 may be used in accordance with techniques of this disclosure. In some examples, components of conversation model 152 may be located in a singular location. In other examples, one or more components of conversation model 152 may be in different locations (e.g., connected via network 130). That is, in some examples conversation model 152 may be part of a conventional computing device, while in other examples, conversation model 152 may be part of a distributed or “cloud” computing system. Further, conversation model 152 may be located in and executed by a computing system remote from and communicatively coupled to computing device 102. In such examples, computing device 102 may send and receive messages, data, or otherwise exchange information with the remote computing system such that the remote computing system provides computing device 102 with the functionality of conversation model 152. In some examples, conversation model 152 may be functionally split between computing device 102 and one or more remote computing systems such that a portion of the functionality provided by conversation model 152 is performed locally at computing device 102 and other portions of the functionality are performed by the one or more remote computing systems.

UI module 106 may interpret inputs detected at UIC 104. UI module 106 may relay information about the inputs detected at UIC 104 to one or more associated platforms, operating systems, applications, and/or services executing at computing device 102 to cause computing device 102 to perform a function. UI module 106 may also receive information and instructions from one or more associated platforms, operating systems, applications, and/or services executing at computing device 102 (e.g., caller application 108) for generating a GUI. In addition, UI module 106 may act as an intermediary between the one or more associated platforms, operating systems, applications, and/or services executing at computing device 102 and various output devices of computing device 102 (e.g., speakers, LED indicators, vibrators, etc.) to produce output (e.g., graphical, audible, tactile, etc.) with computing device 102.

Caller application 108 may include functionality for placing and receiving calls via network 130 to and from remote computing devices such as remote computing device 136. Examples of caller application 108 may include a phone dialer application, a Voice over IP (VoIP) application, a messaging application with voice calling functionality, a video conferencing application, a video calling application, or any other application that includes functionality for placing and receiving phone calls.

In the example of FIG. 1A, applications 112 may send data to UI module 106 that causes UIC 104 to generate user interfaces (GUIs), such as GUIs 114A-114D (collectively “GUIs 114”) and elements thereof. In response, UI module 106 may output instructions and information to UIC 104 that cause UIC 104 to display a user interface (e.g., GUI 114A) according to the information received from the application. When handling input detected by UIC 104, UI module 106 may receive information from UIC 104 in response to inputs detected at locations of a screen of UIC 104 at which elements of the user interface are displayed. UI module 106 disseminates information about inputs detected by UIC 104 to other components of computing device 102 for interpreting the inputs and for causing computing device 102 to perform one or more functions in response to the inputs.

In accordance with aspects of this disclosure, computing device 102 may establish a call with remote computing device 136, such as by placing a call to remote computing device 136 via network 130 or receiving a call from remote computing device 136 via network 130. Examples of calls placed and received by computing device 102 may include a voice call such as a telephone call or a Voice over Internet Protocol (VoIP) call, a video call such as a videoconferencing call, a real-time mixed reality session, a real-time augmented reality session, a media call, or any other calls between two or more devices. Once computing device 102 has established the call with remote computing device 136, computing device 102 and remote computing device 136 may be able to exchange audio data. Computing device 102 may send, to remote computing device 136 during the call, audio data such as spoken words and phrases. Similarly, computing device 102 may receive, from remote computing device 136 during the call, audio data such as words and phrases spoken by a user of remote computing device 136.

Computing device 102 may, in response to receiving an incoming call, determine whether to alert the user of computing device 102 to the incoming call, such as by determining whether to ring (e.g., audibly outputting a ringtone and/or outputting a haptic pattern) to alert the user of computing device 102 to the incoming call. Computing device 102 may determine whether to alert the user of computing device 102 to the incoming call based at least in part on determining whether the incoming call is a spam call. Computing device 102 may determine whether the incoming call is a spam call using any suitable spam detection technique, such as by determining whether the phone number associated with the incoming call is on a list of known spam callers, whether the user of computing device 102 had previously marked the phone number associated with the incoming call as a spam caller, and the like. If computing device 102 determines that the incoming call is a spam call, computing device 102 may reject the call and/or may send the incoming call to voicemail without alerting the user to the incoming call.

In some examples, computing device 102 may determine whether to alert the user of computing device 102 to the incoming call based at least in part on whether the user is available to take the call. Computing device 102 may determine whether the user is available to take the call based on contextual information such as whether the do not disturb feature of computing device 102 is turned on, the schedule of the user as stored in the calendar of computing device 102 (e.g., whether the user is currently in a meeting as scheduled in the calendar), the current time and/or date, the current location of computing device 102, the current state of the user (e.g., if the user is currently driving or if the user is currently sleeping), and the like.

If computing device 102 determines that the user of computing device 102 is not available to take the incoming call, computing device 102 may send the incoming call to voicemail without alerting the user to the incoming call. In some examples, computing device 102 may execute caller application 108 to perform automatic call screening of an incoming call to gather certain information from the party calling from remote computing device 136, such as the identity of the party (e.g., the name of the caller and/or the identity of the entity that is calling), the purpose of the call, and/or any other relevant information. As described below, computing device 102 may perform call screening to conduct a natural language conversation with the caller associated with remote computing device 136 and may store a transcript of the conversation and a recording of the conversation for later review by the user of computing device 102.

In the example of FIG. 1A, if computing device 102 determines to alert the user of computing device 102 to an incoming call, computing device 102 may, in response to receiving an incoming call from remote computing device 136, execute caller application 108 to send data to UI module 106 that causes UIC 104 to display GUI 114A to alert the user of computing device 102 to the incoming call. For example, UIC 104 may display GUI 114A while ringing (e.g., audibly outputting a ringtone and/or outputting a haptic pattern) to alert the user of computing device 102 to the incoming call.

GUI 114A may include call information 124 associated with the incoming call, such as the phone number from which the incoming call originated, the name of the person or entity associated with the phone number or whether the name of the person or entity associated with the phone number is unknown, and the like. GUI 114A may include call answering UI element 120 that the user may select (e.g., by providing user input at UIC 104) to answer the call.

GUI 114A may also include call screen UI element 122 that user may select (e.g., by providing user input at UIC 104) to cause computing device 102 to perform call screening of the incoming call. Computing device 102 may execute caller application 108 to perform call screening of an incoming call to gather certain information from the party calling from remote computing device 136, such as the identity of the party (e.g., the name of the caller and/or the identity of the entity that is calling), the purpose of the call, and/or any other relevant information.

Computing device 102 may perform call screening of an incoming call without the user of computing device 102 having to answer the call and without the user of computing device 102 having to converse with the party calling from remote computing device 136. Rather, caller application 108 may perform call screening of an incoming call by answering the call to establish the call between computing device 102 and remote computing device 136 and by conducting a natural language conversation with the party calling from remote computing device 136 using a human-like voice with human-like vocal characteristics. That is, caller application 108 may receive, from remote computing device 136, utterances, such as words, phrases and sentences spoken by a user of remote computing device 136, and to generate natural language utterances, such as spoken words, phrases and sentences, that are sent to remote computing device 136, such as by audibly outputting the natural language utterances in the call.

Caller application 108 may be able to conduct the natural language conversation with remote computing device 136 to gather certain information from the party calling from remote computing device 136, such as the identity of the party (e.g., the name of the caller and/or the identity of the entity that is calling), the purpose of the call. Caller application 108 may be able to record the audio of the call and save a transcript of the call at computing device 102 so that the user of computing device 102 may be able to listen to a recording of the call and/or read the transcript of the call at a later time.

Caller application 108 may be able to conduct the natural language conversation with remote computing device 136 without user interactions. That is, caller application 108 is able to generate utterances and to send such utterances to remote computing device 136 in the call without user interaction. For example, caller application 108 may, in response to receiving an utterance from remote computing device 136, determine an appropriate response to the utterance without user input that indicates how caller application 108 should respond to the received utterance. In this way caller application 108 may be able to conduct a multi-tum natural language conversation with remote computing device 136.

As caller application 108 performs call screening of the call, caller application 108 may refrain from outputting audio of the natural language conversation being conducted with remote computing device 136. Caller application 108 may also refrain from transmitting, to remote computing device 136, any audio that may be captured by audio input devices (e.g., microphones) of UIC 104 and/or may disable such audio input devices of UIC 104. Rather, to enable the user of computing device 102 to follow along with the natural language conversation being conducted between computing device 102 and remote computing device 136, caller application 108 may, as caller application 108 performs call screening of the call received from remote computing device 136 by conducting the natural language conversation in the call with remote computing device 136, output a real-time text transcript of the natural language conversation taking place during the call.

As shown in FIG. 1A, caller application 108 may, as part of performing call screening of an incoming call from remote computing device 136, send data to UI module 106 that causes UIC 104 to display GUI 114B that includes a real-time transcript 116A of the conversation taking place in the call between computing device 102 and remote computing device 136. As can be seen in the real-time transcript 116A of the conversation, caller application 108 may start off the conversation by greeting the party using remote computing device 136 and by asking for the purpose of the call (e.g., “Go ahead and say why you're calling”).

Caller application 108 may, while conducting the conversation, detect a prolonged silence during the call, such as by determining that caller application 108 has not received an utterance from remote computing device 136 for a certain amount of time (e.g., 5 seconds, 10 seconds, etc.). Caller application 108 may, in response to detecting the prolonged silence, prompt the calling party to speak (e.g., “I'm sorry I didn't catch that. What did you say?”). Caller application may conduct the conversation to gather information regarding the call, such as the name of the caller and the purpose of the call. As such, if caller application 108 determines, based on the conversation that has been conducted, that the calling party has identified themselves but has not stated their purpose for the call, caller application 108 may ask for the purpose of the call (e.g., “go ahead and say why you're calling”).

Caller application 108 may use conversation model 152 to determine one or more words, one or more phrases, one or more sentences, and the like that is to be spoken as part of the conversation and to generate utterances of such words, phrases, and sentences as part of the conversation. Conversation model 152 may include one or more neural networks, such as a generative adversarial network (GAN), a recurrent neural network (RNN), and the like that is trained via machine learning on a corpus of anonymized phone conversation data to determine a reply to utterances received from remote computing device 136.

For example, caller application 108 may, in response to receiving an utterance in the call from remote computing device 136, use automatic speech recognition to convert the utterance into text and may input the converted text into conversation model 152 along with any other relevant contextual information such as previous utterances in the conversation during the call (e.g., words, phrases, and/or sentences previously spoken by the parties on the call), the vocal characteristics (e.g., intonation) of utterances received from remote computing device 136, whether the identity of the remote computing device 136 is listed in the contacts of computing device 102, the location of computing device 102 and/or remote computing device 136, the current time and/or date, events listed in an calendar application of computing device 102, previous conversations with the party using remote computing device 136, or any other relevant contextual information. Conversation model 152 may determine, based on the inputted data, one or more words, phrases, and/or words that caller application 108 may convert (e.g., via text-to-speech) to an utterance that caller application 108 may send as part of the conversation to remote computing device 136.

In accordance with aspects of this disclosure, as computing device 102 conducts the conversation with remote computing device 136, caller application 108 may determine one or more candidate replies that are relevant to the conversation. Caller application 108 may output indications of the one or more candidate replies for display at UIC 104 to enable the user of computing device 102 to select a candidate reply. Caller application 108 may generate and send a reply in the conversation that corresponds to the selected candidate reply.

Caller application 108 may determine one or more candidate replies that are relevant to the conversation. In the case of a conversation, relevant replies to the conversation may be replies that are relevant to replying to the utterance that was most recently received from remote computing device 136 as part of the conversation and/or replies that are highly likely or probable to be selected by the user to respond to the utterance that was most recently received from remote computing device 136 as part of the conversation.

Caller application 108 may determine the one or more candidate replies based on contextual information, such as contextual information associated with the call. Such contextual information may include previous utterances in the conversation during the call (e.g., words, phrases, and/or sentences previously spoken by the parties on the call), the vocal characteristics (e.g., intonation) of utterances received from remote computing device 136, whether the identity of the remote computing device 136 is listed in the contacts of computing device 102, whether the caller is from a business or other entity, the location of computing device 102 and/or remote computing device 136, the current time and/or date, events listed in an calendar application of computing device 102, previous conversations with the party using remote computing device 136, a use case of the call, or any other relevant contextual information.

Caller application 108 may use conversation model 152 to determine one or more candidate replies. For example, caller application 108 may, in response to receiving an utterance in the call from remote computing device 136, input the contextual information into conversation model 152 to determine, based on the inputted data, one or more candidate replies that are relevant to the conversation.

Caller application 108 may output an indication of each of the one or more candidate replies, such as for display at UIC 104, so that a user may interact with UIC 104 to select a candidate reply out of the one or more candidate replies. In the example of FIGS. 1A and 1B, as computing device 102 continues to conduct the conversation with remote computing device 136, caller application 108 may send data to UI module 106 that causes UIC 104 to display GUI 114C that includes UI elements 132A and 132B that each corresponds to a candidate reply determined by computing device 102.

GUI 114C also includes an updated real-time transcript 116B of the conversation. taking place in the call between computing device 102 and remote computing device 136. As shown in the updated real-time transcript 116B of the conversation, the party at remote computing device 136 is calling to confirm a doctor's appointment for 2 PM tomorrow. Caller application 108 may determine one or more candidate replies that are relevant to the conversation, such as by determining that the party at remote computing device 136 is calling to confirm a doctor's appointment for 2 PM tomorrow. Caller application 108 may therefore determine one or more candidate replies to reply to the request to confirm the appointment, such as a candidate reply confirming the appointment and a candidate reply to not confirm the appointment, and caller application 108 may cause GUI 114C to include UI element 132A that corresponds to the candidate reply confirming the appointment and UI element 132B that correspond to the candidate reply to not confirm the appointment.

Computing device 102 may receive, from UIC 104, an indication of a user input that selects a candidate reply from the one or more candidate replies and may, in response, send a reply in the conversation that corresponds to the selected candidate reply. For example, if the user interacts with UIC 104 to select UI element 132A, UI module 106 may receive, from UIC 104, an indication of user input that selects UI element 132, and caller application 108 may receive, from UI module 106, an indication that the user has selected UI element 132 corresponding to the candidate reply confirming the appointment.

Caller application 108 may not necessarily send a reply that is word-for-word the same as the candidate reply. Instead, caller application 108 may generate a reply (e.g., one or more words, phrases, and/or sentences) having the same or similar meaning to the selected candidate reply, and may send, as part of the conversation, a spoken version of the reply to remote computing device 136.

As shown in FIG. 1B, in response to the user interacting with UIC 104 to select UI element 132A that corresponds to the candidate reply confirming the appointment, caller application 108 may generate a reply confirming the appointment and may send, as part of the conversation, the reply to remote computing device 136. Caller application 108 may send data to UI module 106 that causes UIC 104 to display GUI 114D that includes an updated real-time transcript 116C of the conversation. As can be seen in the updated real-time transcript 116C of the conversation, caller application 108 may generate a reply of “Yes we confirm the appointment for 2 PM tomorrow” and may send the reply as part of the conversation to remote computing device 136.

As caller application 108 continues to perform call screening of the call and conducts the conversation with remote computing device 136, caller application 108 may continue to update the candidate replies that are outputted for display by UIC 104. That is, the candidate replies determined by caller application 108 does not remain static during the call screening process, but may adaptively change depending on the context of the call and/or the conversation, thereby enabling the user to select candidate replies that are relevant to the current context of the call.

While the call screening techniques described in FIGS. 1A and 1B relate to call screening of incoming calls, the call screening techniques described herein may also be applied to outgoing calls. For example, the user of computing device 102 may direct caller application 108 to place an outgoing call to perform a task, such as to book a restaurant reservation. Caller application 108 may be able to place such a call and conduct a natural language conversation, such as described above, during the call in order to accomplish the task.

The techniques of this disclosure enables a computing device to reduce the amount of user interaction required to answer calls such as telephone calls or other voice calls. By performing call screening of incoming calls and conducting a natural language conversation with the calling party, the techniques of disclosure may not require the user of a computing device to have to speak in the call or to listen to the call. Furthermore, by determining candidate replies to the conversation that are relevant to the conversation and by enabling the user to select a candidate reply to reply to the conversation taking place, the techniques of this disclosure may enable the user to reply to questions or queries received in the call without having to speak in the call or to listen to the call.

Being able to conduct a natural language conversation with the calling party and enabling the user to reply to questions or queries received in the call without requiring the user to have to speak or listen to the call may enable people with disabilities, such as people with social anxiety or people with hearing and/or speech disabilities, or people who do not enjoy speaking on the phone, to be able to use the computing device to answer incoming calls without needing additional specialized devices and/or services, such as a speech to speech relay service. Being able to conduct a natural language conversation with the calling party and enabling the user to reply to questions or queries received in the call without requiring the user to have to speak or listen to the call may also prevent malicious parties from learning what the user's voice sounds like and may prevent malicious parties from potentially capturing the user's voice and using the user's voice for malicious purposes.

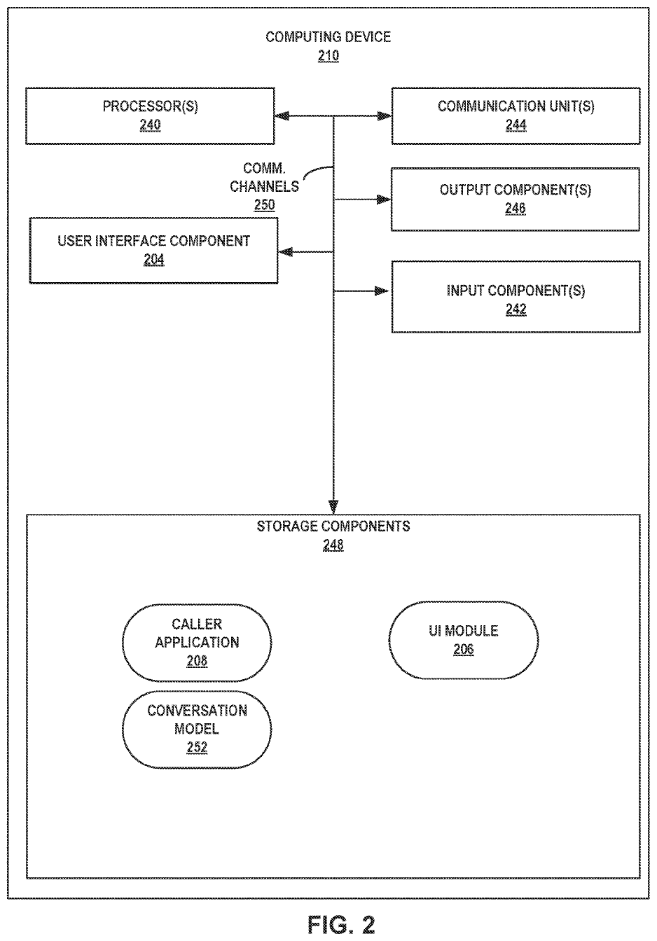

FIG. 2 is a block diagram illustrating further details of an example computing device, in accordance with one or more aspects of the present disclosure. Computing device 202 of FIG. 2 is described below as an example of computing device 102 as illustrated in FIGS. 1A and 1B.

Computing device 202 of FIG. 2 may be an example of a mobile phone, a tablet computer, a laptop computer, a desktop computer, a server, a mainframe, a set-top box, a television, a wearable device, a home automation device or system, a gaming system, a media player, an e-book reader, a mobile television platform, an automobile navigation or infotainment system, or any other type of mobile, non-mobile, wearable, and non-wearable computing device configured to communicate with a network, such as network 130 as illustrated in FIGS. 1A and 1B. FIG. 2 illustrates only one particular example of computing device 202, and many other examples of computing device 202 may be used in other instances and may include a subset of the components included in example computing device 202 or may include additional components not shown in FIG. 2.

As shown in the example of FIG. 2, computing device 202 includes user interface component (UIC) 204, one or more processors 240, one or more input components 242, one or more communication units 244, one or more output components 246, and one or more storage components 248. Storage components 248 of computing device 202 also include user interface (UI) module 206, caller application 208, and conversation model 252. UI module 206 is an example of UI module 106 of FIGS. 1A and 1B, and caller application 208 is an example of caller application 108 of FIG. 1A and 1B. Conversation model 252 is an example of conversation model 152 of FIGS. 1A and 1B.

Communication channels 250 may interconnect each of the components 240, 204, 244, 246, 242, and 248 for inter-component communications (physically, communicatively, and/or operatively). In some examples, communication channels 250 may include a system bus, a network connection, an inter-process communication data structure, or any other method for communicating data.

One or more input components 242 of computing device 202 may receive input. Examples of input are tactile, audio, and video input. One or more input components 242 of computing device 202, in one example, includes a presence-sensitive display, touch-sensitive screen, mouse, keyboard, voice responsive system, video camera, microphone or any other type of device for detecting input from a human or machine.

One or more output components 246 of computing device 202 may generate output. Examples of output are tactile, audio, and video output. One or more output components 246 of computing device 202, in one example, includes a presence-sensitive display, sound card, video graphics adapter card, speaker, liquid crystal display (LCD), light-emitting diode (LED) display, miniLED, microLED, organic light-emitting diode (OLED) display, a light field display, haptic motors, linear actuating devices, or any other type of device for generating output to a human or machine.

One or more communication units 244 of computing device 202 may communicate with external devices via one or more wired and/or wireless networks by transmitting and/or receiving network signals on the one or more networks. Examples of one or more communication units 244 include a network interface card (e.g., an Ethernet card), an optical transceiver, a radio frequency transceiver, a GPS receiver, or any other type of device that can send and/or receive information. Other examples of one or more communication units 244 may include short wave radios, cellular data radios, wireless network radios, as well as universal serial bus (USB) controllers.

UIC 204 of computing device 202 may be hardware that functions as an input and/or output device for computing device 202. For example, UIC 204 may include a display component, which may be a screen at which information is displayed by UIC 204 and a presence-sensitive input component that may detect an object at and/or near the display component.

One or more processors 240 may implement functionality and/or execute instructions within computing device 202. For example, one or more processors 240 on computing device 202 may receive and execute instructions stored by storage components 248 that execute the functionality of UI module 206, caller application 208, and conversation model 252. The instructions executed by one or more processors 240 may cause computing device 202 to store information within storage components 248 during program execution. Examples of one or more processors 240 include application processors, display controllers, sensor hubs, and any other hardware configured to function as a processing unit. One or more processors 240 may execute instructions of Ul module 206, caller application 208, and conversation model 252 to perform actions or functions. That is, UI module 206, caller application 208, and conversation model 252 may be operable by one or more processors 240 to perform various actions or functions of computing device 202.

One or more storage components 248 within computing device 202 may store information for processing during operation of computing device 202. That is, computing device 202 may store data accessed by UI module 206, caller application 208, and conversation model 252 during execution at computing device 202. In some examples, storage component 248 is a temporary memory, meaning that a primary purpose of storage component 248 is not long-term storage. Storage components 248 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 may be configured to store larger amounts of information than volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with UI module 206, caller application 208, and conversation model 252.

One or more processors 240 are configured to execute UI module 206, caller application 208, and conversation model 252 to perform any combination of the techniques described in this disclosure. For example, one or more processors 240 are configured to execute caller application 208 to receive an incoming call from a remote computing device (e.g., remote computing device 136 of FIG. 1A) and to determine whether to alert the user of computing device 202 to the incoming call, such as by determining whether to ring (e.g., audibly outputting a ringtone and/or outputting a haptic pattern) to alert the user of computing device 202 to the incoming call. One or more processors 240 are configured to execute caller application 208 to determine whether to alert the user of computing device 202 to the incoming call based at least in part on determining whether the incoming call is a spam call. One or more processors 240 are configured to execute caller application 208 to determine whether the incoming call is a spam call using any suitable spam detection technique, such as by determining whether the phone number associated with the incoming call is on a list of known spam callers, whether the user of computing device 202 had previously marked the phone number associated with the incoming call as a spam caller, and the like. If computing device 202 determines that the incoming call is a spam call, one or more processors 240 are configured to execute caller application 208 to reject the call and/or may send the incoming call to voicemail without alerting the user to the incoming call.

In some examples, one or more processors 240 are configured to execute caller application 208 to determine whether to alert the user of computing device 202 to the incoming call based at least in part on whether the user is available to take the call. One or more processors 240 are configured to execute caller application 208 to determine whether the user is available to take the call based on contextual information such as whether the do not disturb feature of computing device 202 is turned on, the schedule of the user as stored in the calendar of computing device 202 (e.g., whether the user is currently in a meeting as scheduled in the calendar), the current time and/or date, the current location of computing device 202, the current state of the user (e.g., if the user is currently driving or if the user is currently sleeping), and the like.

If caller application 208 determines that the user of computing device 202 is not available to take the incoming call, one or more processors 240 are configured to execute caller application 208 to send the incoming call to voicemail without alerting the user to the incoming call. In some examples, one or more processors 240 are configured to execute caller application 208 to perform automatic call screening of an incoming call to gather certain information from the party calling from the remote computing device, such as the identity of the party (e.g., the name of the caller and/or the identity of the entity that is calling), the purpose of the call, and/or any other relevant information. As described throughout this disclosure, one or more processors 240 are configured to execute caller application 208 to perform call screening to conduct a natural language conversation with the caller associated with the remote computing device and may store a transcript of the conversation and a recording of the conversation for later review by the user of computing device 202.

If caller application 208 determines to alert the user of computing device 202 to an incoming call, one or more processors 240 are to ring computing device 202 (e.g., audibly outputting a ringtone and/or outputting a haptic pattern) to alert the user of computing device 202 to the incoming call and to enable the user to direct computing device 202 to perform call screening of the incoming call. If the user of computing device 202 directs computing device 202 to perform call screening of the incoming call, such as by interacting with UIC 204 to provide user input that corresponds to selection of call screening user interface element, one or more processors 240 are configured to execute caller application 208 to perform call screening of the incoming call.

One or more processors 240 are configured to execute caller application 208 to perform call screening of an incoming call to gather certain information from the party calling from the remote computing device, such as the identity of the party (e.g., the name of the caller and/or the identity of the entity that is calling), the purpose of the call, and/or any other relevant information. Caller application 208 may perform call screening of an incoming call without the user of computing device 202 having to answer the call and without the user of computing device 202 having to converse with the party calling from the remote computing device. Rather, one or more processors 240 are configured to execute caller application 208 to perform call screening of an incoming call by answering the call to establish the call between computing device 202 and the remote computing device and by conducting a natural language conversation with the party calling from the remote computing device. That is, caller application 208 is able to receive, from the remote computing device, utterances, such as words, phrases and sentences spoken by a user of the remote computing device, and to generate natural language utterances, such as spoken words, phrases and sentences, that are sent to the remote computing device.

Caller application 208 may be able to conduct the natural language conversation with the remote computing device to gather certain information from the party calling from the remote computing device, such as the identity of the party (e.g., the name of the caller and/or the identity of the entity that is calling), the purpose of the call. Caller application 208 may be able to record the audio of the call and save a transcript of the call at computing device 202 so that the user of computing device 202 may be able to listen to a recording of the call and/or read the transcript of the call at a later time.

Caller application 208 may be able to conduct the natural language conversation with the calling party of the remote computing device without user interactions. That is, caller application 108 is able to generate utterances and to send such utterances to the remote computing device in the call without user interaction. For example, one or more processors 240 are configured to execute caller application 208 to, in response to receiving an utterance from the remote computing device, determine an appropriate response to the utterance without user input that indicates how caller application 208 should respond to the received utterance. In this way caller application 208 may be able to conduct a multi-turn natural language conversation with the calling party at the remote computing device.

As caller application 208 performs call screening of the call, one or more processors 240 are configured to execute caller application 208 to refrain from outputting audio of the natural language conversation being conducted with the remote computing device. One or more processors 240 are configured to execute caller application 208 to also refrain from transmitting, to the remote computing device, any audio that may be captured by audio input devices (e.g., microphones) of UIC 204 and/or may disable such audio input devices of UIC 204. Rather, to enable the user of computing device 202 to follow along with the natural language conversation being conducted between computing device 202 and the remote computing device 136, one or more processors 240 are configured to execute caller application 208 to output, for display at UIC 204, a real-time text transcript of the natural language conversation taking place during the call. For example, one or more processors 240 are configured to execute caller application 208 to perform a speech-to-text transcription of the call to generate the real-time transcript of the conversation taking place during the call.

One or more processors 240 are configured to execute caller application 208 to conduct the conversation to gather information regarding the call, such as the name of the caller and the purpose of the call. Caller application 208 may use conversation model 252 to determine one or more words, one or more phrases, one or more sentences, and the like that is to be spoken as part of the conversation and to generate utterances of such words, phrases, and sentences as part of the conversation. Conversation model 252 may include one or more neural networks, such as a generative adversarial network (GAN), a recurrent neural network (RNN), and the like that is trained via machine learning on a corpus of anonymized phone conversation data to determine a reply to utterances received by caller application 208 during the call.

For example, one or more processors 240 are configured to execute caller application 208 to, in response to receiving an utterance in the call, perform automatic speech recognition to convert the utterance into text and to input the converted text into conversation model 252 along with any other relevant contextual information, such as previous utterances in the conversation during the call (e.g., words, phrases, and/or sentences previously spoken by the parties on the call), the vocal characteristics (e.g., intonation) of utterances received in the call, whether the identity of the remote computing device is listed in the contacts of computing device 202, the location of computing device 202 and/or the remote computing device, the current time and/or date, events listed in an calendar application of computing device 202, previous conversations with the party using the computing device, or any other relevant contextual information. One or more processors 240 are configured to execute conversation model 252 to determine, based on the inputted data, one or more words, phrases, and/or words that caller application 208 may convert (e.g., via text-to-speech) to an utterance that caller application 208 may send as part of the conversation to the remote computing device.

In some examples, one or more processors 240 are configured to execute conversation model 252 to generate words, phrases, and sentences in different conversational styles based on user preferences and/or contextual information associated with the call. For example, one or more processors 240 are configured to execute conversation model 252 to determine the conversational style of the conversation in the call, such as by determining, based on the conversation that has already been conducted during the call, whether the conversation style of the conversation is formal or casual, and may generate words, phrases, and sentences according to the determined conversation style. In another example, one or more processors 240 are configured to execute conversation model 252 to generate words, phrases, and sentences in a casual conversation style if conversation model 252 determines that the call is with a personal friend of the user of computing device 202, and to generate words, phrases, and sentences in a formal conversation style if conversation model determines that the call is a business call.

As computing device 102 conducts the conversation with the remote computing device, one or more processors 240 are configured to execute caller application 208 to determine one or more candidate replies that are relevant to the conversation and may output indications of the one or more candidate replies for display at UIC 204 to enable the user of computing device 202 to select a candidate reply. One or more processors 240 are configured to execute caller application 208 to, in response to the user of computing device 202 selecting a candidate reply, generate and send a reply in the conversation that corresponds to the selected candidate reply.

One or more processors 240 are configured to execute caller application 208 to determine one or more candidate replies that are relevant to the conversation. In the case of a conversation, relevant replies to the conversation may be replies that are relevant to replying to the utterance that was most recently received from the remote computing device as part of the conversation and/or replies that are highly likely or probable to be selected by the user to respond to the utterance that was most recently received from the remote computing device as part of the conversation.

Caller application 208 may determine the one or more candidate replies based on contextual information, such as contextual information associated with the call. Such contextual information may include previous utterances in the conversation during the call (e.g., words, phrases, and/or sentences previously spoken by the parties on the call), the vocal characteristics (e.g., intonation) of utterances received from the remote computing device, whether the identity of the remote computing device is listed in the contacts of computing device 202, the location of computing device 202 and/or the remote computing device, the current time and/or date, events listed in an calendar application of computing device 202, previous conversations with the party using the computing device, or any other relevant contextual information.

Caller application 208 may use conversation model 252 to determine one or more candidate replies. For example, one or more processors 240 are configured to execute caller application 208 to, in response to receiving an utterance in the call from the remote computing device, input the contextual information into conversation model 252, and one or more processors 240 are configured to execute conversation model 252 to determine, based on the inputted data, one or more candidate replies that are relevant to the conversation.

One or more processors 240 are configured to execute caller application 208 to output an indication of each of the one or more candidate replies, such as for display at UIC 204, so that a user may interact with UIC 204 to select a candidate reply out of the one or more candidate replies. The user of computing device 202 may provide user input at UIC 204 to select a candidate reply out of the one or more candidate replies displayed by UIC 204, and one or more processors 240 are configured to execute UI module 206 to send an indication of the selected candidate reply. One or more processors 240 are configured to execute caller application 208 to, in response to receiving the indication of the selected candidate reply, send, based at least in part on the selected candidate reply, a reply in the conversation that corresponds to the candidate reply. That is, caller application 208 may generate a reply (e.g., one or more words, phrases, and/or sentences) having the same or similar meaning to the selected candidate reply, and may send, as part of the conversation, a spoken version of the reply to the remote computing device.

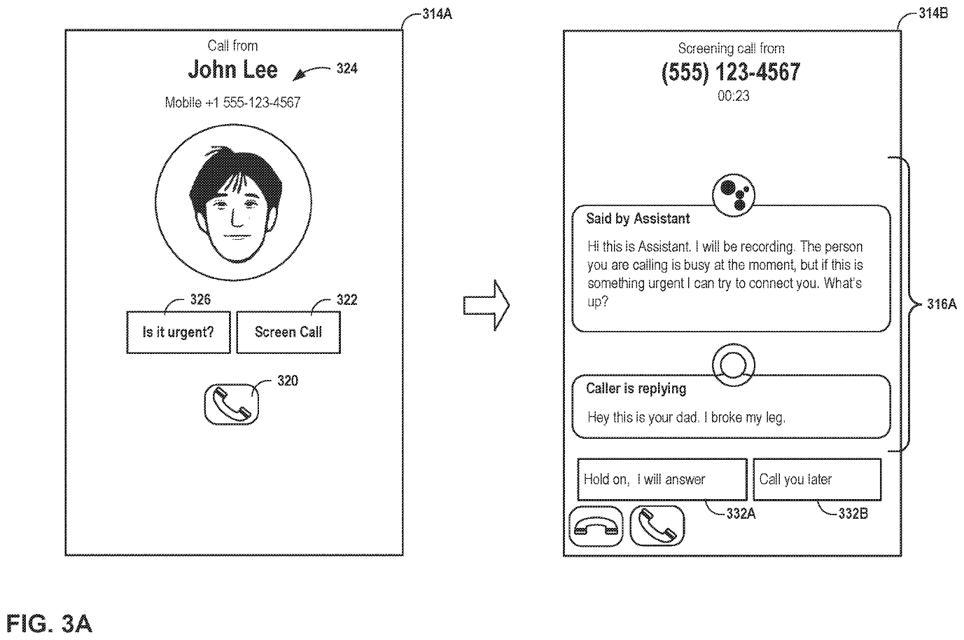

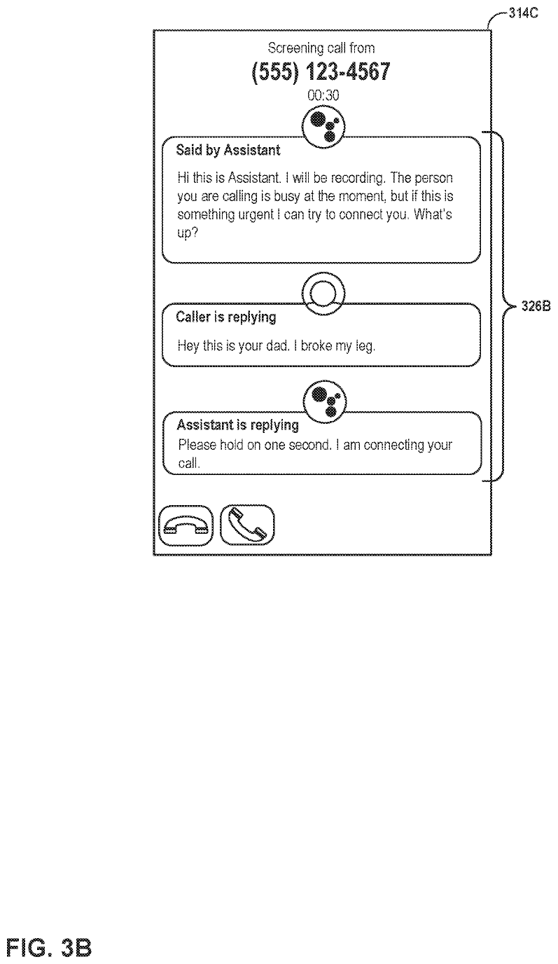

FIGS. 3A and 3B illustrates techniques for call screening of incoming calls, in accordance with aspects of this disclosure. FIGS. 3A and 3B are described with respect to computing device 202 of FIG. 2.

As described above, when computing device 202 receives an incoming call, computing device 202 may perform call screening of an incoming call, which may include conducting a natural language conversation with the calling party to gather certain information from the calling party. As computing device 202 performs the call screening, computing device 202 may determine and output candidate replies that are relevant to the conversation, and the user of computing device 202 may select a candidate reply that may cause computing device 202 to formulate and send a reply in the call that corresponds to the selected candidate reply.

In accordance with aspects of this disclosure, computing device 202 may enable the user of computing device 202 to determine the greeting that computing device 202 may send during the call screening when conducting the natural language conversation with the calling party. Computing device 202 may, in response to receiving an incoming call, determine one or more candidate greetings relevant to the incoming call with which computing device 202 may greet the calling party of the incoming call. Computing device 202 may output an indication of each of the one or more candidate greetings, such for display at UIC 204, and the user of computing device 202 may interact with UIC 204, such as by providing user input at UIC 204, to select a candidate greeting out of the one or more candidate greetings. Computing device 202 may, in response to selection of the candidate greeting, perform call screening of the incoming call that includes sending a greeting that corresponds to the selected candidate greeting as part of the natural language conversation.

Computing device 202 may determine the one or more candidate greetings based on contextual information associated with the incoming call, such as the identity of the calling party (e.g., the phone number of the calling party), whether the calling party is stored in the contacts of computing device 202, the time of day, the location of computing device 202, and the like.

In the example of FIG. 3A, computing device 202 may, in response to receiving an incoming call, execute caller application 208 to send data to UI module 206 that causes UIC 204 to display GUI 314A to alert the user of computing device 202 to the incoming call. For example, UIC 204 may display GUI 314A while ringing (e.g., audibly outputting a ringtone and/or outputting a haptic pattern) to alert the user of computing device 202 to the incoming call.

GUI 314A may include call information 324 associated with the incoming call, such as the phone number from which the incoming call originated, the name of the person or entity associated with the phone number or whether the name of the person or entity associated with the phone number is unknown, and the like. As illustrated in GUI 314A, because the identity (e.g., phone number) of the incoming call is stored in the contacts of computing device 202, computing device 202 may be able to output the name of the caller as part of call information 324 and may also output a picture of the caller in GUI 314A. GUI 314A may include call answering UI element 320 that the user may select (e.g., by providing user input at UIC 204) to answer the call and call screen UI element 322 that user may select (e.g., by providing user input at UIC 204) to cause computing device 202 to perform call screening of the incoming call, as described above with respect to FIGS. 1A and 1B.

In accordance with aspects of this disclosure, computing device 202 may, in response to receiving an incoming call, also determine one or more candidate greetings relevant to the incoming call. Computing device 202 may determine one or more candidate greetings relevant to the incoming call based on the caller type of the calling party (e.g., the person making the incoming call), such as whether the calling party is listed in the contacts of computing device 202, whether the calling party is a business or entity, and the like. For example, computing device 202 may determine, based on information such as the identity of the calling party (e.g., the phone number of the incoming call), the caller type of the calling party, the one or more candidate greetings relevant to the incoming call.

In the example of FIG. 3A, because the identity of the calling party is stored in the contacts of computing device 202, computing device 202 may determine a candidate greeting of “Is it urgent?” that is relevant to the incoming call, and computing device 202 may output an indication of the candidate greeting, such as by including candidate greeting UI element 326 that is labeled “Is it urgent?” in GUI 314A displayed by UIC 204. The user of computing device 202 may provide user input, such as touch input, to interact with UIC 204 to select candidate greeting UI element 326. In response, UI module 206 may send an indication of the user input that corresponds to selection of the candidate greeting that corresponds to UI element 326 to, e.g., caller application 208, and computing device 202 may, in response, start performing call screening of the incoming call, including sending a greeting that corresponds to the selected candidate greeting of “Is this urgent?” as part of the natural language conversation with the calling party.

Computing device 202 may execute caller application 208 to send data to UI module 206 that causes UIC 204 to display GUI 314B, which may be a call screening user interface that includes a real-time transcript 316A of the natural language conversation being conducted by computing device 202 with the calling party as part of the call screening.

Computing device 202 may start off the conversation with the calling party by determining a greeting that corresponds to the selected candidate greeting of “Is this urgent?”. For example, computing device 202 may determine a greeting that is a phrase or a sentence that asks the calling party whether the call is urgent. Computing device 202 may therefore convert the greeting to speech and may send the speech to the calling party as part of the natural language conversation.

As computing device 202 performs call screening and conducts the conversation with the calling party, computing device 202 may also determine one or more candidate replies that are relevant to the call. In the example of FIG. 3A, computing device 202 may receive, as part of the call, an utterance from the calling party of “Hey this is your dad. I broke my leg,” and computing device 202 may, in response, determine one or more candidate replies to the utterance received from the calling party. For example, computing device 202 may determine a candidate reply of “Hold on, I will answer” and a candidate reply of “Call you later” that are relevant to the utterance from the calling party, and may output, in GUI 314B, candidate reply UI element 332A associated with the candidate reply of “Hold on, I will answer” and candidate reply UI element 332B associated with the candidate reply of “Call you later”.

The user of computing device 202 may provide user input, such as touch input, to interact with UIC 204 to select candidate reply UI element 332A associated with the candidate reply of “Hold on, I will answer.” In response, UI module 206 may send an indication of the user input that corresponds to selection of the candidate reply that corresponds to candidate reply UI element 332A to, e.g., caller application 208, and computing device 202 may, in response, formulate and send a reply in the call that corresponds to the selected candidate reply. That is, computing device 202 may determine a reply that is a phrase or a sentence that indicates that the user of computing device 202 will join the call. Computing device 202 may therefore convert the reply corresponding to the selected candidate reply to speech and may send the speech to the calling party as part of the natural language conversation. As shown in FIG. 3B, computing device 202 may execute caller application 208 to send data to UI module 206 that causes UIC 204 to display GUI 314C that includes an updated real-time transcript 316B of the natural language conversation being conducted by computing device 202 that includes the reply of “Please hold on one second. I am connecting your call” corresponding to the selected candidate reply.

Because the intent of the selected candidate reply of “Hold on, I will answer” indicates an intent for the user of computing device 202 to join the call, computing device 202 may also, in response to the user selecting candidate reply UI element 332A associated with the candidate reply of “Hold on, I will answer”, end call screening of the incoming call without disconnecting the call. Instead, computing device 202 may maintain the call and may enable the user of computing device 202 to pick up the call and to start vocally communicating with the calling party via the call (e.g., by speaking to the calling party and to listen to what is said by the calling party).

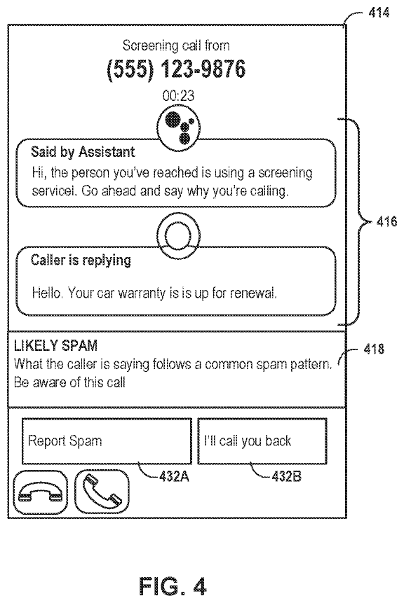

FIG. 4 illustrates additional techniques for call screening, in accordance with aspects of this disclosure. FIG. 4 is described below in the context of computing device 202 of FIG. 2.

As computing device 202 performs call screening of an incoming call and conducts a natural language conversation with the calling party, computing device 202 may be able to determine, based on the conversation being conducted with the calling party, whether the incoming call is a spam call. For example, computing device 202 may determine based on the pattern of utterances received from the calling party, keywords contained within the utterances received from the calling party, or any other relevant contextual information, whether the incoming call is a spam call and/or may determine the likelihood (e.g., probability) that the incoming call is a spam call.

If computing device 202 determines that the incoming call is likely to be a spam call, such as by determining the probability that the incoming call is higher than a probability threshold (e.g., greater than 80% probability, greater than 90% probability, etc.), computing device 202 may output, for display at UIC 204, an indication that the incoming call is likely to be a spam call. Computing device 202 may provide the ability for the user to report the spam call to an external computing system that may add the spam call to a spam example repository that may be used for training and testing spam detection systems.

As shown in FIG. 4, when computing device 202 performs call screening of an incoming call, computing device 202 may execute caller application 208 to send data to UI module 206 that causes UIC 204 to display GUI 414, which may be a call screening user interface that includes a real-time transcript 416 of the natural language conversation being conducted by computing device 202 with the calling party as part of the call screening. Computing device 202 may, in response to detecting that the incoming call is likely to be a spam call, output, in GUI 414, a user interface element 418 indicating the call is likely to be a spam call. Computing device 202 may also include a user interface element 432A that the user may select to cause computing device 202 to report the spam call to an external computing system that may add the spam call to a spam example repository that may be used for training and testing spam detection systems. In some examples, computing device 202 may also output user interface element 432B that the user may select to reply to the calling party that the user will call back the calling party at a later time.

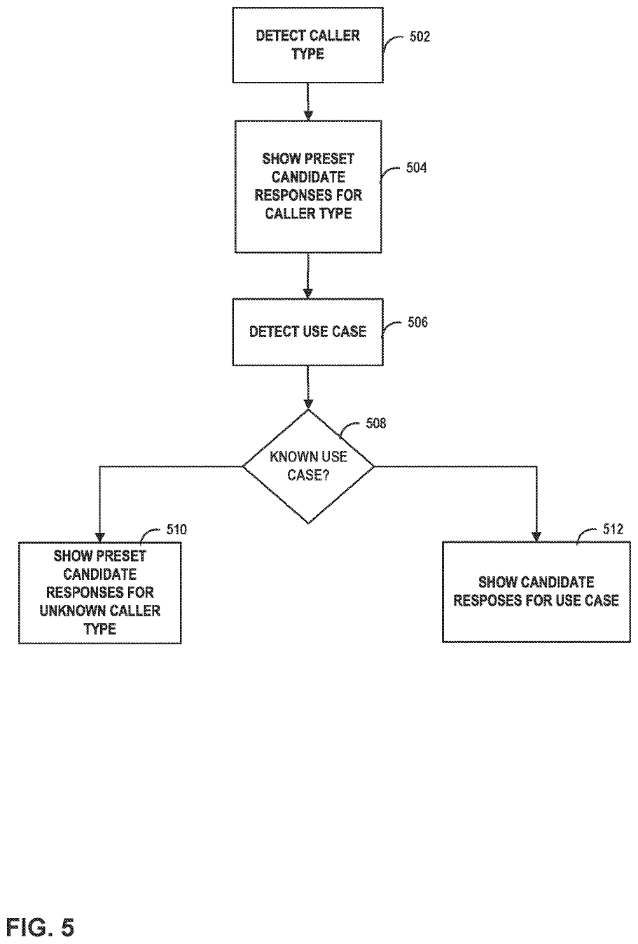

FIG. 5 is a flowchart illustrating an example technique for determining one or more candidate replies, in accordance with aspects of this disclosure. FIG. 5 is described below in the context of computing device 202 of FIG. 2.

As described throughout this disclosure, computing device 202 may perform call screening of incoming calls and may conduct a natural language conversation with the caller of the incoming call. As computing device 202 conducts the natural language conversation, computing device 202 may determine one or more candidate replies that are relevant to the natural language conversation. Computing device 202 may output the set of candidate replies for display at UIC 204. A user may select a candidate reply out of the candidate replies displayed at UIC 204, and computing device 202 may, in response, formulate and send a reply in the call that corresponds to the selected candidate reply.

In the example of FIG. 5, computing device 202 may be able to determine one or more candidate replies that are relevant to the natural language conversation based at least in part on a caller type of the caller (i.e., the party that places the incoming call) and/or the use case of the incoming call. To that end, computing device 202 may, in response to receiving an incoming call, determine the caller type of the caller (502). The caller type may be one of: contact/favorites/work, unknown number, spam, or business. Callers that are a contact/favorites/work caller type, a business type, or a spam type may be referred to as known caller types, while callers that are of an unknown number type may be referred to as unknown caller types.

A caller that is the contact/favorites/work caller type may be a caller having contact details that have already been stored in computing device 202, such as a caller having a phone number that is stored in the contacts of computing device 202. A caller that is a business type may be a caller that computing device 202 determines is from a business (e.g., a store, a doctor's office, etc.) or another entity (e.g., a school, a charity, etc.). Computing device 202 may be able to determine that a caller is a business type by determining that the phone number of the caller is a phone number associated with a business or another entity. A caller that is a spam type may be a caller that computing device 202 determines is placing spam calls. Computing device 202 may be able to determine that a caller is a spam type by determining that the phone number of the caller is a phone number associated with spam calls. If computing device 202 is unable to determine that a caller is a contact/favorites/work caller type, a business type, or a spam type, computing device 202 may determine that the caller is of an unknown number type.

During call screening of a call, computing device 202 may determine a set of candidate replies associated with the caller type of the caller and may output the determined set of candidate replies, such as for display at UIC 204 (504). A user may select a candidate reply, and computing device 202 may formulate and send a reply in the call that corresponds to the selected candidate reply.

If computing device 202 determines that the caller is the contact/favorites/work caller type, computing device 202 may determine the set of candidate replies to be: “Is it urgent?”, “Can you repeat?”, “Tell me more”, “I can't understand”, “Can you text me?”, “I'll text you”, “Be right there”, and “I'll call you back”. If computing device 202 determines that the caller is the business caller type, computing device 202 may determine the set of candidate replies to be: “Report spam”, “Can you repeat?”, “Tell me more”, “I can't understand”, “Can you text me?”, “Who is this?”, “Call back later”, and “Wrong number”. If computing device 202 determines that the caller is the spam caller type, computing device 202 may determine the set of candidate replies to be: “Wrong number” and “Take me off your list”.

If computing device 202 determines that the caller is the unknown number type, computing device 202 may determine the set of candidate replies to be: Report spam”, “Can you repeat?”, “Tell me more”, “I can't understand”, “Who is this?”, “Call back later”, “I'll get back to you”, and “Wrong number”.

As computing device 202 conducts the natural language conversation during the call, computing device 202 may be able to update the caller type of the caller based at least in part on the contextual information associated with the call, such as based on the context of the natural language conversation. For example, computing device 202 may initially determine that the caller is the unknown number type. As computing device 202 performs call screening of the call and conducts a natural language conversation during the call, computing device 202 may determine, based on contextual information such as the contents of the conversation, that the caller is not the unknown number type but is instead a business caller type.

Computing device 202 may therefore update the caller type of the caller and may, in response to updating the caller type of the caller, update the candidate replies for the call to the candidate replies associated with the business caller type. For example, if computing device 202 determines that the caller is not the unknown number type but is instead a business caller type, computing device 202 may update the candidate replies that are outputted at UIC 204 to the candidate replies associated with the business caller type: “Report spam”, “Can you repeat?”, “Tell me more”, “I can't understand”, “Can you text me?”, “Who is this?”, “Call back later”, and “Wrong number”.

In another example, computing device 202 may initially determine that the caller is the unknown number type. As computing device 202 performs call screening of the call and conducts a natural language conversation during the call, computing device 202 may determine, based on contextual information such as the contents of the conversation, that the caller is not the unknown number type but is instead a spam caller type. Computing device 202 may update the caller type of the caller to the spam caller type and may, in response to updating the caller type of the caller, update the candidate replies for the call to the candidate replies associated with the spam caller type. For example, if computing device 202 determines that the caller is not the unknown number type but is instead a spam caller type, computing device 202 may update the candidate replies that are outputted at UIC 204 to be the candidate replies associated with the spam caller type: “Wrong number” and “Take me off your list”.

In addition to determining the caller type of the caller, computing device 202 may also determine the use case of the call (506). A use case of the call may be the purpose of the caller in calling computing device 202. Computing device 202 may determine the use case of the call based on any contextual information related to the call, such as the context of the natural language conversation being conducted, keywords detected in the natural language conversation being conducted, vocal characteristics of the caller, or any other relevant contextual information. In some examples, computing device 202 may input such contextual information related to the call into conversation model 252 to determine the use case of the call.

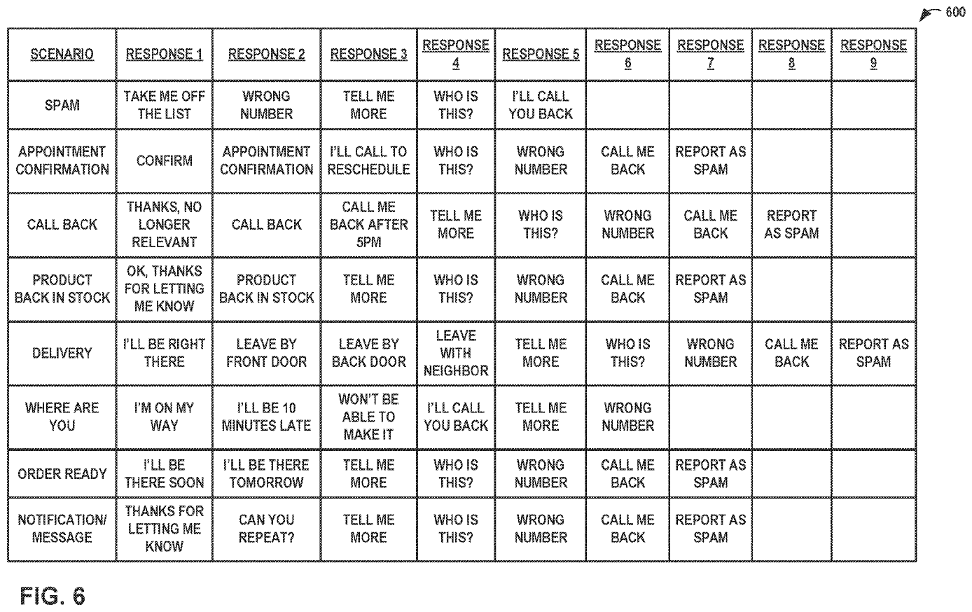

Computing device 202 may determine whether the use case of the call is known, where the use case of the call is unknown if computing device 202 is unable to determine the use case of the call (508). If computing device 202 is unable to determine the use case of the call, computing device 202 may continue to output the set of candidate replies associated with the taller type of the caller (510). If computing device 202 is able to determine the use case of the call, computing device 202 may determine a set of candidate replies associated with the use case of the call, as described in more detail in FIG. 6, and may output the set of candidate replies associated with the use case of the call for display at UIC 204 (512). A user may select a candidate reply, and computing device 202 may formulate and send a reply in the call that corresponds to the selected candidate reply.

In some examples, computing device 202 may determine that the call includes dial pad options, which may include detecting, in the utterances from the calling party, a request to press certain numbers of a dial pad, such as “press 1 to for English”. If computing device 202 determines that the call includes dial pad options, computing device 202 may determine the set of candidate replies to include “report spam” and “wrong number”.

FIG. 6 illustrates example candidate replies associated with use cases of a call, in accordance with aspects of this disclosure. FIG. 6 is described below in the context of computing device 202 of FIG. 2.

As shown in FIG. 6, table 600 illustrates different use cases of a call that may be determined by computing device 202, such as spam, appointment confirmation, call back, product back in stock, delivery, where are you, order ready, and notification/message. A call having a spam use case may be a spam call. A call having an appointment confirmation use case may be a call from a business or other entity to confirm an appointment. A call having a call back use case may be a call from a caller that is calling back the user of computing device 202. A call having a product back in stock use case may be a call from a business or other entity to inform the user of computing device 202 that a product the user is interested in is back in stock. A call having a delivery use case may be a call to inform the user of computing device 202 that an item ordered by the user (e.g., a food order) has arrived. A call having a where are you use case is a call to query the user of computing device 202 regarding the user's location. A call having an order ready use case may be a call from a business or other entity to inform the user of computing device 202 that an item ordered by the user (e.g., a food order) is ready to be picked up. A call having a notification/message use case may be a call to notify the user of computing device 202 of a particular situation and/or a call to deliver a message to the user.

As can be seen in table 600, each use case may be associated with a set of candidate replies. Thus computing device 202 may, in response to determining the use case of a call, determine the set of candidate replies associated with the call and may output indications of the set of candidate replies associated with the call at UIC 204. A user may interact with UIC 204 to select a candidate reply out of the candidate replies associated with the call and computing device 202 may, in response to the user selecting a candidate reply, formulate and send a reply in the call that corresponds to the selected candidate reply.

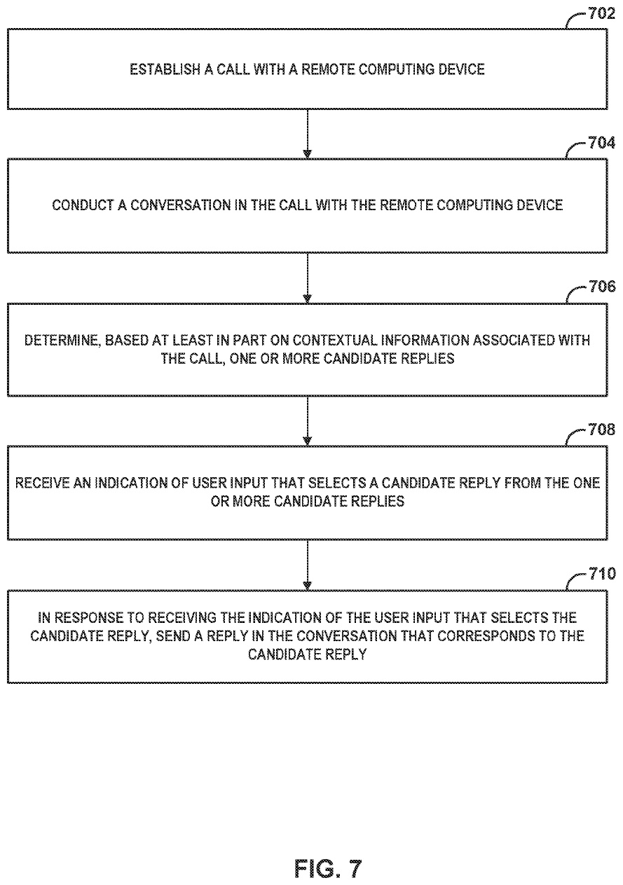

FIG. 7 is a flowchart illustrating example operations performed by an example computing device that is configured to perform call screening, in accordance with one or more aspects of the present disclosure. FIG. 7 is described below in the context of environment 100 of FIG. 1A and computing device 202 of FIG. 2.

As shown in FIG. 7, one or more processors 240 of a computing device 202 may establish a call with a remote computing device 136 (702). One or more processors 240 may conduct a conversation in the call with the remote computing device 136 (704). One or more processors 240 may determine, based at least in part on contextual information associated with the call, one or more candidate replies (706). One or more processors 240 may receive an indication of a user input that selects a candidate reply from the one or more candidate replies (708). One or more processors 240 may, in response to receiving the indication of the user input that selects the candidate reply, send a reply in the conversation that corresponds to the candidate reply (710).

This disclosure includes the following examples.

Example 1. A method comprising: establishing, by one or more processors of a computing device, a call with a remote computing device; conducting, by the one or more processors, a conversation in the call with the remote computing device; determining, by the one or more processors and based at least in part on contextual information associated with the call, one or more candidate replies; receiving, by the one or more processors, an indication of a user input that selects a candidate reply from the one or more candidate replies; and in response to receiving the indication of the user input that selects the candidate reply, sending, by the one or more processors, a reply in the conversation that corresponds to the candidate reply.

Example 2. The method of example 1, wherein the conversation comprises a multi-turn natural language conversation.

Example 3. The method of any of examples 1 and 2, wherein, conducting the conversation in the call with the remote computing device further comprises; receiving, by the one or more processors, a first utterance from the remote computing device; determining, by the one or more processors and based at least in part on contextual information associated with the call, a second utterance to reply to the first utterance; and sending, by the one or more processors, the second utterance to the remote computing device.

Example 4. The method of example 3, wherein determining the second utterance to respond to the first utterance further comprises: determining, by the one or more processors and using one or more neural networks trained on a corpus of phone conversation data, the second utterance to reply to the first utterance.

Example 5. The method of any of examples 1-4, wherein conducting the conversation in the call with the remote computing device further comprises: conducting, by the one or more processors, the conversation to determine an identity of a party that placed the call and a purpose for the call.

Example 6. The method of any of examples 1-5, wherein conducting the conversation in the call with the remote computing device further comprises: detecting, by the one or more processors, silence in the conversation; and in response to detecting the silence in the conversation, prompting, by the one or more processors, a party associated with the remote computing device to speak.

Example 7. The method of any of examples 1-6, wherein determining, the one or more candidate replies that are relevant to the conversation further comprises: determining, by the one or more processors, the one or more candidate replies that are relevant to a latest utterance received in the call from the remote computing device.

Example 8. The method of any of examples 1-7, wherein determining the one or more candidate replies further comprises: determining, by the one or more processors, a caller type associated with the call; and determining, by the one or more processors, the one or more candidate replies based at least in part on the caller type associated with the call.

Example 9. The method of example 8, wherein determining the caller type associated with the call further comprises: determining, by the one or more processors and based at least in part on a phone number associated with the remote computing device, the caller type associated with the call.

Example 10. The method of any of examples 1-9, wherein determining the one or more candidate replies further comprises: determining, by the one or more processors, a use case associated with the call; and determining, by the one or more processors, the one or more candidate replies based at least in part on the use case associated with the call.

Example 11. The method of any of examples 1-10, further comprising: outputting, by the one or more processors and for display at a display device, a real-time transcript of the conversation.

Example 12. The method of any of examples 1-11, wherein the call comprises an incoming call, and wherein establishing the call with the remote computing device and conducting the conversation in the call with the remote computing device further comprises: receiving, by the one or more processors, the incoming call; and answering, by the one or more processors, the incoming call to perform call screening of the incoming call.

Example 13. The method of example 12, wherein answering the incoming call further comprises: determining, by the one or more processors, one or more candidate greetings; receiving, by the one or more processors, an indication of a second user input that selects a candidate greeting from the one or more candidate greetings as a selected candidate greeting; and in response to receiving the indication of the second user input, performing, by the one or more processors, the call screening of the incoming call, including sending, to the remote computing device, a greeting that corresponds to the selected candidate greeting as part of the conversation.

Example 14. The method of example 13, wherein the selected candidate greeting corresponds to asking if the call is urgent, and wherein sending the greeting that corresponds to the selected candidate greeting as part of the conversation further comprises: sending, by the one or more processors and to the remote computing device, the greeting that asks if the call is urgent as part of the conversation.

Example 15. The method of any of examples 1-14, wherein conducting the conversation in the call with the remote computing device further comprises: conducting, by the one or more processors, the conversation in the call with the remote computing device without outputting audio of the conversation being conducted.

Example 16. The method of any of examples 1-15, further comprising: in response to determining the one or more candidate replies, outputting by the one or more processors and for display at a display device, an indication of the one or more candidate replies.

Example 17. A computing device comprising: a memory that stores instructions; and one or more processors that execute the instructions to: establish a call with a remote computing device; conduct a conversation in the call with the remote computing device; determine, based at least in part on contextual information associated with the call, one or more candidate replies; receive an indication of a user input that selects a candidate reply from the one or more candidate replies; and in response to receiving the indication of the user input that selects the candidate reply, send a reply in the conversation that corresponds to the candidate reply.

Example 18. The computing device of example 17, wherein the conversation comprises a multi-turn natural language conversation.

Example 19. The computing device of any of examples 17 and 18, wherein, to conduct the conversation in the call with the remote computing device, the one or more processors further execute the instructions to: receiving, by the one or more processors, a first utterance from the remote computing device; determining, by the one or more processors and based at least in part on contextual information associated with the call, a second utterance to reply to the first utterance; and sending, by the one or more processors, the second utterance to the remote computing device.

Example 20. The computing device of example 19, wherein to determine the second utterance to respond to the first utterance, the one or more processors further execute the instructions to: determine, using one or more neural networks trained on a corpus of phone conversation data, the second utterance to reply to the first utterance.

Example 21. The computing device of any of examples 17-20, wherein to conduct the conversation in the call with the remote computing device, the one or more processors further execute the instructions to: conduct the conversation to determine an identity of a party that placed the call and a purpose for the call.

Example 22. The computing device of any of examples 17-21, wherein to conduct the conversation in the call with the remote computing device, the one or more processors further execute the instructions to: detect silence in the conversation; and in response to detecting the silence in the conversation, prompt a party associated with the remote computing device to speak.

Example 23. The computing device of any of examples 17-22, wherein to determine the one or more candidate replies that are relevant to the conversation, the one or more processors further execute the instructions to: determine the one or more candidate replies that are relevant to a latest utterance received in the call from the remote computing device.

Example 24. The computing device of any of examples 17-23, wherein to determine the one or more candidate replies, the one or more processors further execute the instructions to: determine a caller type associated with the call; and determine the one or more candidate replies based at least in part on the caller type associated with the call.

Example 25. The computing device of example 24, wherein to determine the caller type associated with the call, the one or more processors further execute the instructions to: determine, based at least in part on a phone number associated with the remote computing device, the caller type associated with the call.

Example 26. The computing device of any of examples 17-25, wherein to determine the one or more candidate replies, the one or more processors further execute the instructions to: determine a use case associated with the call; and determine the one or more candidate replies based at least in part on the use case associated with the call.

Example 27. The computing device of any of examples 17-26, wherein the one or more processors further execute the instructions to: outputting, by the one or more processors and for display at a display device, a real-time transcript of the conversation.

Example 28. The computing device of any of examples 17-27, wherein the call comprises an incoming call, and to establish the call with the remote computing device and to conduct the conversation in the call with the remote computing device, the one or more processors further execute the instructions to: receive the incoming call; and answer the incoming call to perform call screening of the incoming call.

Example 29. The computing device of example 28, wherein to answer the incoming call, the one or more processors further execute the instructions to: determine one or more candidate greetings; receive an indication of a second user input that selects a candidate greeting from the one or more candidate greetings as a selected candidate greeting; and in response to receiving the indication of the second user input, perform the call screening of the incoming call, including sending, to the remote computing device, a greeting that corresponds to the selected candidate greeting as part of the conversation.

Example 30. The computing device of example 29, wherein the selected candidate greeting corresponds to asking if the call is urgent, and wherein to send the greeting that corresponds to the selected candidate greeting as part of the conversation, the one or more processors further execute the instructions to: send, to the remote computing device, the greeting that asks if the call is urgent as part of the conversation.

Example 31. The computing device of any of examples 17-30, wherein to conduct the conversation in the call with the remote computing device, the one or more processors further execute the instructions to: conduct the conversation in the call with the remote computing device without outputting audio of the conversation being conducted.

Example 32. The computing device of any of examples 17-31, wherein the one or more processors further execute the instructions to: in response to determining the one or more candidate replies, output, for display at a display device, an indication of the one or more candidate replies.

Example 30. A non-transitory computer-readable storage medium comprising instructions that, when executed, cause one or more processors of a computing device to: establish a call with a remote computing device; conduct a conversation in the call with the remote computing device; determine, based at least in part on contextual information associated with the call, one or more candidate replies; receive an indication of a user input that selects a candidate reply from the one or more candidate replies; and in response to receiving the indication of the user input that selects the candidate reply, send a reply in the conversation that corresponds to the candidate reply.

Example 31. The non-transitory computer-readable storage medium of example 30, wherein the conversation comprises a multi-turn natural language conversation.

Example 32. The non-transitory computer-readable storage medium of any of examples 30 and 31, wherein, to conduct the conversation in the call with the remote computing device, the instructions further cause the one or more processors to: receiving, by the one or more processors, a first utterance from the remote computing device; determining, by the one or more processors and based at least in part on contextual information associated with the call, a second utterance to reply to the first utterance; and sending, by the one or more processors, the second utterance to the remote computing device.

Example 33. The computing device of example 32, wherein to determine the second utterance to respond to the first utterance, the instructions further cause the one or more processors to: determine, using one or more neural networks trained on a corpus of phone conversation data, the second utterance to reply to the first utterance.

Example 34. The computing device of any of examples 30-33, wherein to conduct the conversation in the call with the remote computing device, the instructions further cause the one or more processors to: conduct the conversation to determine an identity of a party that placed the call and a purpose for the call.

Example 35. The computing device of any of examples 30-34, wherein to conduct the conversation in the call with the remote computing device, the instructions further cause the one or more processors to: detect silence in the conversation; and in response to detecting the silence in the conversation, prompt a party associated with the remote computing device to speak.

Example 36. The computing device of any of examples 30-35, wherein to determine the one or more candidate replies that are relevant to the conversation, the instructions further cause the one or more processors to: determine the one or more candidate replies that are relevant to a latest utterance received in the call from the remote computing device.

Example 37. The computing device of any of examples 30-36, wherein to determine the one or more candidate replies, the instructions further cause the one or more processors to: determine a caller type associated with the call; and determine the one or more candidate replies based at least in part on the caller type associated with the call.

Example 38. The computing device of example 37, wherein to determine the caller type associated with the call, the instructions further cause the one or more processors to: determine, based at least in part on a phone number associated with the remote computing device, the caller type associated with the call.

Example 39. The computing device of any of examples 30-38, wherein to determine the one or more candidate replies, the instructions further cause the one or more processors to: determine a use case associated with the call; and determine the one or more candidate replies based at least in part on the use case associated with the call.

Example 40. The computing device of any of examples 30-39, wherein the instructions further cause the one or more processors to: outputting, by the one or more processors and for display at a display device, a real-time transcript of the conversation.

Example 41. The computing device of any of examples 30-40, wherein the call comprises an incoming call, and to establish the call with the remote computing device and to conduct the conversation in the call with the remote computing device, the instructions further cause the one or more processors to: receive the incoming call; and answer the incoming call to perform call screening of the incoming call.

Example 42. The computing device of example 41, wherein to answer the incoming call, the instructions further cause the one or more processors to: determine one or more candidate greetings; receive an indication of a second user input that selects a candidate greeting from the one or more candidate greetings as a selected candidate greeting; and in response to receiving the indication of the second user input, perform the call screening of the incoming call, including sending, to the remote computing device, a greeting that corresponds to the selected candidate greeting as part of the conversation.

Example 43. The computing device of example 42, wherein the selected candidate greeting corresponds to asking if the call is urgent, and wherein to send the greeting that corresponds to the selected candidate greeting as part of the conversation, the instructions further cause the one or more processors to: send, to the remote computing device, the greeting that asks if the call is urgent as part of the conversation.

Example 44. The computing device of any of examples 30-43, wherein to conduct the conversation in the call with the remote computing device, the instructions further cause the one or more processors to: conduct the conversation in the call with the remote computing device without outputting audio of the conversation being conducted.

Example 45. The computing device of any of examples 30-44, wherein the instructions further cause the one or more processors to: in response to determining the one or more candidate replies, output, for display at a display device, an indication of the one or more candidate replies.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of a computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structures suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of inter-operative hardware units, including one or more processors as described above, in conjunction with suitable software and/or firmware.

Various embodiments have been described. These and other embodiments are within the scope of the following claims.

1. A method comprising:
establishing, by one or more processors of a computing device, a call with a remote computing device;
conducting, by the one or more processors, a conversation in the call with the remote computing device;
determining, by the one or more processors and based at least in part on contextual information associated with the call, one or more candidate replies;
receiving, by the one or more processors, an indication of a user input that selects a candidate reply from the one or more candidate replies; and
in response to receiving the indication of the user input that selects the candidate reply, sending, by the one or more processors, a reply in the conversation that corresponds to the candidate reply.

2. The method of claim 1, wherein the conversation comprises a multi-turn natural language conversation, and wherein conducting the conversation in the call with the remote computing device further comprises:
receiving, by the one or more processors, a first utterance from the remote computing device as part of the multi-turn natural language conversation;
determining, by the one or more processors and based at least in part on contextual information associated with the call, a second utterance to reply to the first utterance; and
sending, by the one or more processors, the second utterance to the remote computing device.

3. The method of claim 2, wherein determining the second utterance to respond to the first utterance further comprises:
determining, by the one or more processors and using one or more neural networks trained on a corpus of phone conversation data, the second utterance to reply to the first utterance.

4. The method of claim 1, wherein conducting the conversation in the call with the remote computing device further comprises:
conducting, by the one or more processors, the conversation to determine an identity of a party that placed the call and a purpose for the call.

5. The method of claim 1, wherein conducting the conversation in the call with the remote computing device further comprises:
detecting, by the one or more processors, silence in the conversation; and
in response to detecting the silence in the conversation, prompting, by the one or more processors, a party associated with the remote computing device to speak.

6. The method of claim 1, wherein determining, the one or more candidate replies further comprises:
determining, by the one or more processors, the one or more candidate replies that are relevant to a latest utterance received in the call from the remote computing device.

7. The method of claim 1, wherein determining the one or more candidate replies further comprises:
determining, by the one or more processors, a caller type associated with the call based at least in part on a phone number associated with the remote computing device; and
determining, by the one or more processors, the one or more candidate replies based at least in part on the caller type associated with the call.

8. The method of claim 1, wherein determining the one or more candidate replies further comprises:
determining, by the one or more processors, a use case associated with the call; and
determining, by the one or more processors, the one or more candidate replies based at least in part on the use case associated with the call.

9. The method of claim 1, further comprising:
outputting, by the one or more processors and for display at a display device, a real-time transcript of the conversation.

10. The method of claim 1, wherein the call comprises an incoming call, and wherein establishing the call with the remote computing device and conducting the conversation in the call with the remote computing device further comprises:
receiving, by the one or more processors, the incoming call;
answering, by the one or more processors, the incoming call to perform call screening of the incoming call;
determining, by the one or more processors, one or more candidate greetings;
receiving, by the one or more processors, an indication of a second user input that selects a candidate greeting from the one or more candidate greetings as a selected candidate greeting; and
in response to receiving the indication of the second user input, performing, by the one or more processors, the call screening of the incoming call, including sending, to the remote computing device, a greeting that corresponds to the selected candidate greeting as part of the conversation.

11. The method of claim 10, wherein the selected candidate greeting corresponds to asking if the call is urgent, and wherein sending the greeting that corresponds to the selected candidate greeting as part of the conversation further comprises:
sending, by the one or more processors and to the remote computing device, the greeting that asks if the call is urgent as part of the conversation.

12. The method of claim 1, wherein conducting the conversation in the call with the remote computing device further comprises:
conducting, by the one or more processors, the conversation in the call with the remote computing device without outputting audio of the conversation being conducted.

13. The method of claim 1, further comprising:
in response to determining the one or more candidate replies, outputting by the one or more processors and for display at a display device, an indication of the one or more candidate replies.

14. A computing device comprising:
a memory that stores instructions; and
one or more processors that execute the instructions to:
establish a call with a remote computing device;
conduct a conversation in the call with the remote computing device;
determine, based at least in part on contextual information associated with the call, one or more candidate replies;
receive, by the one or more processors, an indication of a user input that selects a candidate reply from the one or more candidate replies; and
in response to receiving the indication of the user input that selects the candidate reply, send, a reply in the conversation that corresponds to the candidate reply.

15. (canceled)

16. The computing device of claim 14, wherein, to conduct the conversation in the call with the remote computing device, the one or more processors further execute the instructions to:
receive a first utterance from the remote computing device;
determine, based at least in part on contextual information associated with the call, a second utterance to reply to the first utterance; and
send the second utterance to the remote computing device.

17. The computing device of claim 14, wherein the call comprises an incoming call, and, to establish the call with the remote computing device and to conduct the conversation in the call with the remote computing device, the one or more processors further execute the instructions to:
receive the incoming call; and answer the incoming call to perform call screening of the incoming call;
determine one or more candidate greetings;
receive an indication of a second user input that selects a candidate greeting from the one or more candidate greetings as a selected candidate greeting; and
in response to receiving the indication of the second user input, perform the call screening of the incoming call, including sending, to the remote computing device, a greeting that corresponds to the selected candidate greeting as part of the conversation.

18. The computing device of claim 14, wherein to conduct the conversation in the call with the remote computing device, the instructions further cause the one or more processors to:
conduct the conversation to determine an identity of a party that placed the call and a purpose for the call

19. A non-transitory computer-readable storage medium comprising instructions that, when executed, cause one or more processors of a computing device to:
establish a call with a remote computing device; conduct a conversation in the call with the remote computing device;
determine, based at least in part on contextual information associated with the call, one or more candidate replies;
receive an indication of a user input that selects a candidate reply from the one or more candidate replies; and
in response to receiving the indication of the user input that selects the candidate reply, send a reply in the conversation that corresponds to the candidate reply

20. The non-transitory computer-readable medium of claim 19, wherein the conversation comprises a multi-turn natural language conversation, wherein, to conduct the conversation in the call with the remote computing device, the instructions further cause the one or more processors to:
receive, a first utterance from the remote computing device as part of the multi-turn natural language conversation;
determine, based at least in part on contextual information associated with the call, a second utterance to reply to the first utterance; and
send, the second utterance to the remote computing device.

21. The non-transitory computer-readable medium of claim 19, wherein the call comprises an incoming call, and wherein, to establish the call with the remote computing device and to conduct the conversation in the call with the remote computing device, the instructions further cause the one or more processors to:
receive, the incoming call;
determine, one or more candidate greetings;
receive, an indication of a second user input that selects a candidate greeting from the one or more candidate greetings as a selected candidate greeting; and
in response to receiving the indication of the second user input, perform, the call screening of the incoming call, including sending, to the remote computing device, a greeting that corresponds to the selected candidate greeting as part of the conversation.
